(19) United States
(12) Patent Application Publication
(10) Pub. No.: US 2025/0034426 A1
(43) Pub. Date: Jan. 30, 2025

(54) PREPARATION OF AN INSULATING COMPOSITE

(71) Applicant: COATEX, Genay (FR)

(72) Inventors: Laurie PARRENIN, Villeneuve (FR); Jean-Marc SUAU, Lucenay (FR); Morgane LE NEINDRE, Curis-au-Mont-d’Or (FR)

(73) Assignee: COATEX, Genay (FR)

(21) Appl. No.: 18/715,804

(22) PCT Filed: Dec. 19, 2022
(86) PCT No.: PCT/FR2022/000136

§ 371 Date: Jun. 3, 2024

(30) Foreign Application Priority Data
Dec. 20, 2021 (FR) FR2113992

(51) Int. Cl. C09D 133/02; C03C 25/285; C08F 120/06; C08K 5/053; C08K 5/42; C09D 7/63

(52) U.S. Cl. CPC C09D 133/02; C03C 25/285; C08F 120/06; C08K 5/053; C08K 5/42; C09D 7/63

(57) ABSTRACT

A method for preparing a composite material from mineral fibers, by impregnating and then crosslinking an aqueous composition. The method is particularly effective for obtaining a composite having structuring or insulating properties. The aqueous composition includes a polyfunctional compound combined with an alpha-sulfonated polymer and a sulfo-carboxylic acid.

The invention relates to a method for preparing a composite material from mineral fibres, by impregnating and then crosslinking an aqueous composition. The method of the invention is particularly effective for obtaining a composite having structuring or insulating properties. The aqueous composition according to the invention comprises a polyfunctional compound combined with an α-sulfonated polymer and a sulfo-carboxylic acid.

There are known composites with structuring or insulating properties. These composites are generally prepared by crosslinking a composition applied to a material in the form of fibres or particles. After crosslinking, the composition is used to fix the material, in particular to give the final composite its structuring or insulating properties. Improving the ability to trap air in the composite makes it possible to obtain good insulating properties. Similarly, the structuring properties of the final composite can be improved by efficiently binding the material with a cross-linked composition.

Document EP 2333140 describes a binder composition comprising a cross-linking polyol and a polycarboxylic copolymer emulsion and its use in manufacturing by extruding, drawing and then drying an object made of fibreglass. Document EP 1300426 describes the preparation of (meth)acrylic acid copolymers and polyethoxylated isoprenol copolymers in the presence of bisulphite and persulphate.

Known cross-linkable compositions are used when manufacturing composites. However, some compounds should be avoided or removed from these cross-linkable compositions, in particular for efficacy and safety reasons but also for economic or environmental reasons. In particular, the aim is to remove urea-formaldehyde compounds and formaldehyde. It can also be advantageous to be able to dispense with phosphorus compounds when preparing reagents for a cross-linkable composition or when preparing a cross-linkable composition or when applying it prior to crosslinking, since phosphorus compounds are themselves problematic ingredients from an environmental standpoint and limiting or removing them is also a technological challenge.

The reactions involved in crosslinking the composition present on the material must also be effectively controlled. Parasitic reactions or inhibition of the reagents used must be avoided. The formation of degradation by-products or coloured by-products, particularly as a result of excessive exposure to high temperatures, must be reduced or avoided. These cross-linkable compositions should be highly reactive. They should allow for high reaction kinetics.

Usually, the ester or amide is formed during a heated and catalysed reaction. Known effective catalysts comprise phosphorus, in particular phosphorus in oxidation state I, III or V. Reducing or removing a phosphorus catalyst could be offset by increasing the reaction temperature. However, such an increase in temperature can nevertheless lead to a significant degradation in the efficacy of the ester or amide formation. High temperature can cause decarboxylation of the (meth)acrylic polymer and even degradation of the reagents and reaction products.

Moreover, it is always useful to better control the kinetics of the ester or amide formation reaction.

Furthermore, it should be possible to prepare esters or amides in the absence of any compounds that could be considered harmful from an environmental standpoint or in the absence of any compounds that are restricted for use by regulatory provisions. In particular, preparing these compounds in the absence of any compound comprising phosphorus should be preferred, especially the absence of any phosphorus in oxidation state I, III or V. It is also important to have access to improved means, in particular cross-linkable aqueous compositions or cross-linking agents, which are necessary for the manufacture of structuring composites or insulating composites. In particular, these cross-linkable polymers can be applied to a fibrous or particulate material, particularly glass or rock, or to fibres made of organic material, for example organic optical fibres. These polymers can also be used to produce coatings, in particular water-repellent coatings or coatings for mechanical, physico-chemical or chemical protection.

The time required to manufacture these composites is also an important factor. It is therefore important to improve the efficacy of the various reactions involved, particularly during crosslinking.

There is thus a need for improved methods for preparing composites that provide solutions to the problems of the methods in the prior art.

The invention provides a method for preparing a composite material comprising:
the application to a material F chosen among woven heat-resistant substrates, non-woven heat-resistant substrates and combinations thereof, of at least one aqueous composition R comprising:
   a) at least one α-sulphonated polymer A prepared in water and in the absence of any phosphorus compound, by a polymerisation reaction of at least one monomer M chosen among acrylic acid, methacrylic acid, an acrylic acid salt, a methacrylic acid salt and combinations thereof, in the presence of at least one initiator compound and of at least one sulphur compound comprising sulphur in oxidation state IV,
   b) at least one compound B chosen among a sulpho-carboxylic acid, a sulpho-carboxylic acid salt and combinations thereof, present in a molar amount, measured according to the method in the examples, greater than 2% relative to the molar amount of sulphur IV,
   c) at least one polyfunctional compound C chosen among polyols, polyamines, amino alcohols, (polyamino) alcohols, amino (polyalcohols), oses, osides and combinations thereof,
the crosslinking of material F impregnated with composition R.

Preferably according to the invention, at least one of the application or cross-linking steps is carried out at a pH of less than 5, preferably at a pH of less than 4 or less than 3.5. The pH of composition R can be lowered in the cross-linking step.

According to the invention, crosslinking is generally carried out at a temperature ranging from 100 to 250° C., preferably from 150 to 240° C. or from 170 to 230° C.

Preferably for the method according to the invention, material F is in the form of heat-resistant particles or in the form of heat-resistant fibres. These heat-resistant materials are generally unaffected by exposure to temperatures above 125° C. They can comprise a fraction of fibres or of particles of a material that is not heat resistant. According to the invention, material F can be chosen among aramid fibres, ceramic fibres, non-graphite carbon fibres, polyimide fibres, stone wool, slag fibres, glass fibres and combinations thereof. Stone wool can include basalt, coke, lime, recycled materials such as slag and production scraps. More preferably, material F can be chosen among stone wool, slag fibres and glass fibres.

Essentially according to the invention, polymer A is prepared in the absence of any phosphorus compound. It therefore does not comprise a phosphorus group within its structure. Nevertheless, the method for preparing material F according to the invention can use certain phosphorus compounds: in particular, it can use at least one compound chosen among a compound comprising phosphorus in oxidation state I, a compound comprising phosphorus in oxidation state III, a compound comprising phosphorus in oxidation state V and combinations thereof.

The method can also use other compounds: in particular, it can use at least one compound chosen among methane sulphonic acid, 2-sulphoacetic acid, para-toluenesulphonic acid (PTSA), sulphuric acid, their salts and combinations thereof. Composition R can also comprise at least one compound chosen among a compound comprising phosphorus in oxidation state I, a compound comprising phosphorus in oxidation state III, a compound comprising phosphorus in oxidation state V and combinations thereof.

Advantageously, the preparation method according to the invention avoids the use of these phosphorus compounds. It can therefore be used in the absence of a compound comprising phosphorus in oxidation state I or in the absence of a compound comprising phosphorus in oxidation state III or in the absence of a compound comprising phosphorus in oxidation state V. Composition R according to the invention thus comprises no phosphorus compound. Composition R thus does not comprise any compound comprising phosphorus in oxidation state I or does not comprise any compound comprising phosphorus in oxidation state III or does not comprise any compound comprising phosphorus in oxidation state V.

Particularly advantageously, the preparation method according to the invention avoids the use of other chemical compounds or substances. The method according to the invention can therefore be used in the absence of urea-formaldehyde compounds or of formaldehyde compounds. Composition R according to the invention therefore does not comprise a urea-formaldehyde compound or a formaldehyde compound.

Essentially according to the invention, polymer A is an α-sulphonated polymer. It therefore comprises a sulphonated group in the end position. Preferably according to the invention, polymer A is chosen among an α-@-disulphonated polymer A1, an α-monosulphonated polymer A2 and combinations thereof. Polymer A1 therefore comprises a single sulphonated group at one of its end positions, while polymer A2 comprises a sulphonated group at each of its two end positions.

Essentially for the invention, polymer A is prepared using monomer M. Preferably according to the invention, monomer M is chosen among acrylic acid, an acrylic acid salt and combinations thereof.

According to the invention, monomer M can be combined with at least one other monomer, preferably another monomer chosen among vinyl acetate, ethyl acrylate, methyl acrylate, hydroxyethylmethacrylate, hydroxyethylacrylate, hydroxy propylmethacrylate, hydroxypropylacrylate, 2-acrylamido-2-methylpropane sulphonic acid (AMPS), maleic acid, maleic anhydride, itaconic acid and combinations thereof. When combined with another monomer, monomer M can be chosen among acrylic acid, an acrylic acid salt and combinations thereof, in combination with at least one other monomer chosen among vinyl acetate, ethyl acrylate, methyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid and combinations thereof. In combination with another monomer, the amount by weight of the other monomer is less than the amount by weight of monomer M.

Preferably according to the invention, monomer M is acrylic acid alone.

Essentially, polymer A is prepared during a polymerisation reaction of monomer M in the presence of a sulphur compound comprising sulphur IV. Preferably, the sulphur compound is chosen among lithium hydrogen sulphite, sodium hydrogen sulphite, potassium hydrogen sulphite, ammonium hydrogen sulphite, calcium di(hydrogen sulphite), magnesium di(hydrogen sulphite) and combinations thereof. Preferentially according to the invention, the sulphur compound is a mono-hydrogen sulphite. The preferred sulphur compound is sodium hydrogen sulphite, also known as sodium bisulphite.

Preferably according to the invention, the molar amount of sulphur compound, preferably the molar amount of sulphur IV, is comprised between 1% and 15%, preferably between 1.5% and 12%, relative to the total molar amount of monomers used. More preferably, the molar amount of sulphur compound, preferably the molar amount of sulphur IV, is comprised between 1% and 15%, preferably between 1.5% and 12%, relative to the total molar amount of unsaturated groups in the monomers used.

According to the invention, crosslinking is generally carried out at a temperature ranging from 100 to 250° C., preferably from 150 to 240° C. or from 170 to 230° C.

Preferably, the polymerisation reaction is carried out at a temperature above 30° C. and below 100° C., preferably below 90° C., more preferentially below 80° C. or below 75° C. Preferably during the polymerisation reaction to prepare polymer A, the initiator compound is chosen among a peroxide (for example hydrogen peroxide), a hydroperoxide (for example tert-butyl hydroperoxide), a persulphate (for example sodium persulphate, ammonium persulphate, potassium persulphate), combinations thereof and their combinations with a metal salt, preferably a metal salt chosen among an iron salt (for example Fe II or Fe III), a copper salt (for example Cu I or Cu II) and combinations thereof.

Preferably, polymer A has a weight-average molecular mass Mw (measured by SEC) less than 20,000 g/mol, preferably less than 15,000 g/mol, less than 10,000 g/mol, more preferentially less than 7,000 g/mol or less than 6,000 g/mol. Polymer A generally has a weight-average molecular mass Mw (measured by SEC) greater than 1,000 g/mol or greater than 1,200 g/mol.

Preferably, polymer A has a polymolecularity index PI (measured by SEC) of less than 4 or ranging from 1.2 to 4 or from 1.5 to 4; from 1.2 to 3 or from 1.5 to 3: from 1.2 to 2.5 or even from 1.5 to 2.5.

According to the invention, the molecular weight or mass of polymer A is determined by Size Exclusion Chromatography (SEC). A test portion of the polymer solution corresponding to 90 mg of dry solids is placed into a 10 mL flask. Mobile phase is added, together with 0.04% of dimethylformamide (DMF), until a total mass of 10 g is reached. The composition of this mobile phase is as follows: NaHCO₃:0.05 mol/L, NaNO₃: 0.1 mol/L, triethanolamine: 0.02 mol/L, NaN₃ 0.03% by mass. The SEC chain is composed of a Waters 510 isocratic pump with a flow rate set to 0.8 mL/min, of a Waters 717+ sample changer, of an oven containing a Waters Ultrahydrogel Column Guard precolumn 6 cm long and 40 mm in inner diameter, followed by a Waters Ultrahydrogel linear column 30 cm long and 7.8 mm in inner diameter. Detection is provided by means of a Waters 410 RI differential refractometer. The oven is brought to a temperature of 60° C. and the refractometer is brought to a temperature of 45° C. The SEC instrument is calibrated with a series of polyacrylate sodium standards supplied by Polymer Standard Service with a molecular weight at the top of the peak comprised between 900 and 2,250,000 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using PSS WinGPC Scientific software v 4.02. The chromatogram obtained is incorporated into the zone corresponding to molecular weights of more than 250 g/mol. According to the invention, polymer A can be non-neutralised or it can be partially neutralised or completely neutralised. Preferably, polymer A is non-neutralised. According to the invention, the carboxyl groups of polymer A can be partially neutralised at a rate of 70 to 97 mol %, preferably at a rate of 90 to 95 mol %. Polymer A can be partially or completely neutralised by means of at least one monovalent ion or of at least one divalent ion. According to the invention, polymer A can be partially or completely neutralised by means of a combination of at least one monovalent ion and of at least one divalent ion.

According to the invention, polymer A can then be completely or partially neutralised in variable relative molar proportions of monovalent and divalent ions. Preferably according to the invention, the monovalent ion/divalent ion molar proportions are comprised between 90/10 and 10/90 or between 80/20 and 20/80, preferably between 80/20 and 60/40, for example 70/30 or 50/50.

According to the invention, neutralisation can be carried out by means of a primary amine, of a secondary amine or of a monovalent ion chosen among K⁺, Na⁺, Li⁺, NH₄⁺ and combinations thereof. The preferred ion is NH₄⁺. According to the invention, neutralisation can also be carried out by means of a divalent ion chosen among Ca²⁺, Mg²⁺ and combinations thereof. The preferred divalent ion is Ca²⁺.

According to the invention, polymer A can be neutralised by means of at least one compound chosen among NaOH, KOH, ammonium derivatives, ammonia, primary amine, secondary amine, CaO, Ca(OH)₂, MgO, Mg(OH)₂ and combinations thereof. Neutralising polymer A with ammonia is particularly advantageous when using composition R at a pH of less than 7, preferably at a pH of less than 5. According to the invention, polymer A can be completely or partially neutralised by means of an amine base, for example a base chosen among ethylenediamine, 1,3-propanediamine, 1,4-butanediamine, 1,5-pentanediamine, 1,6-hexanediamine, α,α′-diaminoxylene, diethylenetriamine, triethylenetetramine, tetraethylenepentamine, triethanolamine, aminomethyl propanol or 2-amino-2-methyl-propanol (AMP) and combinations thereof. Advantageously according to the invention, the amine base can also be present in composition R as an amine compound C.

According to the invention, α-sulphonated polymer A is a water-soluble polymer: it is different from an emulsion or a latex.

Essentially, the method according to the invention uses a compound B in an acid form or in the form of a salt, preferably a sodium salt or an ammonium salt. Compound B can be added to polymer A and to compound C during the preparation of composition R. Compound B can also be derived from the polymerisation reaction of monomer M in the presence of the sulphur compound. When it is generated in situ, compound B is derived from the monomer M used. Preferably according to the invention, compound B is chosen among sulpho-carboxy-aromatic acids and sulpho-carboxy-alkyl acids, preferably 3-sulphopropionic acid, 3-sulpho-2-methyl-propionic acid, sulpho-succinic acid, their salts and combinations thereof. The preferred compound B is 3-sulphopropionic acid. Preferred salts of compound B are chosen among sodium salt, potassium salt, lithium salt, calcium salt, magnesium salt and ammonium salt. The sodium salt and ammonium salt of compound B are particularly preferred.

Preferably according to the invention, composition R comprises a molar amount of compound B greater than 5%, preferably greater than 10% or greater than 15%, more preferentially greater than 20% or greater than 25%, relative to the molar amount of sulphur IV. Also preferably according to the invention, the molar amount of compound B is less than 60%, preferably less than 50% or less than 40%, relative to the molar amount of sulphur IV.

According to the invention, the molar amount of compound B present in composition R relative to the molar amount of sulphur IV is therefore generally comprised within the ranges of 2% to 60% or of 2% to 50% or of 2% to 40%, preferably of 5% to 60% or of 5% to 50% or of 5% to 40%. Also preferably, the molar amount of compound B present in composition R relative to the molar amount of sulphur IV is therefore generally comprised within the ranges of 10% to 60% or of 10% to 50% or of 10% to 40%. Also preferably, the molar amount of compound B present in composition R relative to the molar amount of sulphur IV is comprised within the ranges of 15% to 60% or of 15% to 50% or of 15% to 40% or of 25% to 60% or of 25% to 50% or of 25% to 40% or even of 20% to 60% or of 20% to 50% or of 20% to 40%.

According to the invention, compound B and the amount of compound B (mol % relative to the molar amount of sulphur IV of the sulphur compound used) are determined by sulphate ion assay and by ¹H NMR and ¹³C NMR analysis of the sulphonated groups of polymer A and of compound B.

Also essentially, the method according to the invention uses a compound C. Compound C can be of synthetic origin or of natural origin, for example an ose or an oside. The oses (simple sugars) are chosen among aldoses and ketoses. Osides are chosen among holosides, in particular among oligoholosides, polyholosides (for example amylose, amylopectin, cellulose, glycogen), homopolyosides, heteropolyosides or among heterosides, in particular among O-heterosides, N-heterosides, S-heterosides.

Preferably according to the invention, compound C is chosen among glycerol, polyalkylene glycol (preferably polyalkylene glycol, polypropylene glycol, poly butylene glycol), pentaerythritol, triethanolamine, ethanolamine, diethanolamine, 3-amino-1-propanol, 1-amino-2-propanol, butanetriol, ethylene glycol, 1,3-propanediol, 1,4-butanediol, 1,6-hexanediol, pentaerythritol, sorbitol, 5-amino-1-pentanol, N-(2-aminoethyl) ethanolamine, 2-(2-aminoethoxy) ethanol, bis(N-hydroxyethyl) propane-1,3-diamine, diisopropanolamine, triisopropanolamine, N-methyldiethanolamine, N-butyldiethanolamine, ethylene glycol, diethylene glycol, triethylene glycol, 1,2-propanediol, 1,3-propanediol, 1,2,3-propanetriol, 1,2-butanediol, 1,4-butanediol, 2,3-butanediol, neopentyl glycol, trimethylolpropane, 1,2,4-butanetriol, 1,2-pentanediol, 1,5-pentanediol, 1,6-hexanediol, 2,5-dimethyl-2,5-hexanediol, D-arabinose, L-arabinose, D-xylose, D-glucose, D-mannose, D-galactose, D-glucosamine, D-fructose, maltose, sucrose, lactose, ethylenediamine, diethylenetriamine, triethylenetetramine, 1,3-diaminopropane, 1,2-diaminopropane, neopentyldiamine, hexamethylenediamine, octamethylenediamine, N-(2-aminoethyl) propane-1,3-diamine, 1,2,3-propanetriamine, N,N-bis(3-aminopropylamine) and combinations thereof, preferably chosen among glycerol, triethanolamine, trimethylolpropane, 1,2,4-butanetriol, ethylene glycol, 1,3-propanediol, 1,4-butanediol, 1,6-hexanediol, pentaerythritol, sorbitol and combinations thereof. Also preferably, compound C has a molecular mass ranging from 50 g/mol to 1,000 g/mol, preferably from 55 g/mol to 500 g/mol or from 55 g/mol to 250 g/mol.

Preferentially according to the invention, composition R comprises a molar amount of functional groups of compound C ranging from 5% to 100%, preferably from 10% to 100% or from 10% to 90% or from 20% to 100% or from 20% to 80%, relative to the total molar amount of carboxyl groups of polymer A.

Advantageously according to the invention, composition R comprises a molar amount of compound C ranging from 5% to 100%, preferably from 10% to 100% or from 10% to 90% or from 20% to 100% or from 20% to 80%, relative to the total molar amount of monomers.

The preparation method according to the invention comprises applying composition R to material F. Preferably, the application is carried out by spraying or dipping. Composition R is then cross-linked by heating in the presence of compound B. Reacting compound C with polymer A results in the final composite material.

Thus, the invention also provides a composite material prepared according to the method according to the invention. Preferably according to the invention, the composite material is chosen among a thermally insulating material, an acoustically insulating material, a fireproofing material and combinations thereof.

When carrying out the method for preparing the composite material according to the invention, the reactivity of composition R according to the invention makes it possible to obtain a particularly effective reactivity when it is cross-linked.

Thus, the invention also provides a method for improving the cross-linking property of an aqueous composition R comprising:
at least one aqueous dispersion of an α-sulphonated polymer A prepared in water and in the absence of any phosphorus compound, by a polymerisation reaction of at least one monomer M chosen among acrylic acid, methacrylic acid, an acrylic acid salt, a methacrylic acid salt and combinations thereof, in the presence of at least one initiator compound and of at least one sulphur compound comprising sulphur in oxidation state IV,
at least one polyfunctional compound C chosen among polyols, polyamines, amino alcohols, (polyamino) alcohols, amino (polyalcohols), oses, osides and combinations thereof,
   comprising the retention of or addition to the aqueous dispersion of polymer A or to the aqueous composition of at least one compound B chosen among a sulpho-carboxylic acid, a sulpho-carboxylic acid salt and combinations thereof, present in a molar amount, measured according to the method in the examples, greater than 2% relative to the molar amount of sulphur IV.

The invention also provides an agent comprising at least one compound C chosen among polyols, polyamines, amino alcohols, (polyamino) alcohols, amino (polyalcohols), oses, osides and combinations thereof, for improving the cross-linking property of an aqueous composition R comprising:
at least one α-sulphonated polymer A prepared in water and in the absence of any phosphorus compound, by a polymerisation reaction of at least one monomer M chosen among acrylic acid, methacrylic acid, an acrylic acid salt, a methacrylic acid salt and combinations thereof, in the presence of at least one initiator compound and of at least one sulphur compound comprising sulphur in oxidation state IV, and
at least one compound B chosen among a sulpho-carboxylic acid, a sulpho-carboxylic acid salt and combinations thereof, and present in a molar amount, measured according to the method in the examples, greater than 2% relative to the molar amount of sulphur IV.

Essentially, the preparation method according to the invention uses a particular aqueous composition. The invention therefore provides an aqueous composition R according to the invention as well as a method for preparing this aqueous composition R.

The method for preparing the aqueous composition R comprises:
the preparation of a polymer A according to the invention,
the retention of or addition to the aqueous dispersion of polymer A of at least one compound B chosen among a sulpho-carboxylic acid, a sulpho-carboxylic acid salt and combinations thereof, and present in a molar amount, measured according to the method in the examples, greater than 2% relative to the molar amount of sulphur IV,
the addition of at least one polyfunctional compound C chosen among polyols, polyamines, amino alcohols, (polyamino) alcohols, amino (polyalcohols), oses, osides and combinations thereof.

The invention also provides a cross-linking agent comprising at least one compound C chosen among polyols, polyamines, amino alcohols, (polyamino) alcohols, amino (polyalcohols), oses, osides and combinations thereof, for crosslinking an aqueous composition R comprising:
at least one α-sulphonated polymer A prepared in water and in the absence of any phosphorus compound, by a polymerisation reaction of at least one monomer M chosen among acrylic acid, methacrylic acid, an acrylic acid salt, a methacrylic acid salt and combinations thereof, in the presence of at least one initiator compound and of at least one sulphur compound comprising sulphur in oxidation state IV, and
at least one compound B chosen among a sulpho-carboxylic acid, a sulpho-carboxylic acid salt and combinations thereof, and present in a molar amount, measured according to the method in the examples, greater than 2% relative to the molar amount of sulphur IV.

According to the invention, the particular, advantageous or preferred characteristics of the method for preparing the composite according to the invention define aqueous compositions R, composite materials, methods for improving the cross-linking property and crosslinking agents according to the invention which are also particular, advantageous or preferred.

The following examples illustrate the various aspects of the invention.

### EXAMPLES

### Preparation and Characterisation of Polymers a According to the Invention

### Preparation of Polymer AA According to the Invention

In a 1 litre glass reactor equipped with a stirrer, a thermometer and a cooling system, a load comprising 0.006 g of iron sulphate heptahydrate and 380 g of water is prepared at room temperature. Then, 3 loads are prepared to be introduced in parallel for 3 hours. In a first beaker 623.5 g of acrylic acid are introduced, in a second beaker 5.086 g of sodium persulphate and 46.6 g of water are introduced, and in a third beaker 122.86 g of a 40% by mass aqueous sodium bisulphite solution are introduced. After 3 hours of addition at 73° C., a clear dispersion of polymer AA is obtained. The concentration of dry solids is 55.2%. Polymer AA has an Mw of 4,430 g/mol and a PI of 2.2.

### Preparation of Polymer AB According to the Invention

In a 1 litre glass reactor equipped with a stirrer, a thermometer and a cooling system, a load comprising 0.023 g of iron sulphate heptahydrate and 284.13 g of water is prepared at room temperature. Then, 3 loads are prepared to be introduced in parallel for 3 hours. First, a load of 0.74 g of sodium persulphate and 19.68 g of water is introduced into the reactor, which has been heated to 80° C. Then, in a first beaker 450.99 g of acrylic acid are introduced, in a second beaker 1.96 g of sodium persulphate and 19.68 g of water are introduced, and in a third beaker 94.23 g of a 40% by mass aqueous sodium bisulphite solution are introduced. After 3 hours of addition at 80° C., a clear dispersion of polymer AB is obtained. This polymer is then neutralised by adding sodium hydroxide to a pH of 2.0. The concentration of dry solids is 50.0%. Polymer AB has an Mw of 6,000 g/mol and a PI of 2.7.

Compound B and the amount of compound B (mol % relative to the molar amount of sulphur IV of the sulphur compound used) contained in each polymer dispersion AA and AB are determined by sulphate ion assay and by ¹H NMR and ¹³C NMR analysis of the sulphonated groups of polymer AA or AB and of compound B.

The sulphate ion levels in the dispersions of polymer AA and AB are determined by ion chromatography. A test portion of about 80 mg of polymer dispersion is introduced into a 15 mL vial. Mobile phase is added to a total mass of 15 g. The composition of the mobile phase is as follows: sodium carbonate: 0.009 mol/L. The ion chromatography chain for the anion assay consists of a Dionex Aquion ion chromatography system with built-in degasser, of which the flow rate is set at 1 mL/min, containing a chemical suppressor, an AG9-HC precolumn, a CG3 metal trap precolumn, an NG1 precolumn and an AG9-HC column. A conductimetric detector is used for detection. The ion chromatography instrument is calibrated with a series of sodium sulphate solution standards. The calibration range is comprised between 0.5 and 100 ppm. The calibration curve is straight-line. The instrument automatically dilutes the samples to ensure that they are within the calibration range. Acquisition and processing of the chromatogram are performed using Chromeleon software 7.2.10.

¹H NMR and ¹³C NMR analyses are carried out using a Bruker AV III HD 500 spectrometer equipped with a 5 mm BBI probe. The polymer samples were dissolved in deuterated water and examined by ¹H NMR and ¹³C NMR using 2D experiments: single and long range ¹H/¹³C correlations.

The dispersions of polymer AA and AB according to the invention comprise 3-sulphopropionic acid as compound B. The results are shown in Table 1.

TABLE 1

| Polymer | AA | AB |
|---|---|---|
| Compound B (%) | 15.0 | 38.8 |

The solids content of the dispersions of polymer AA and AB are measured by heating them at 110° C. in an oven for 1 hour. The results (SC1—% by weight) are shown in Table 2.

### Preparation and Characterisation of Compositions R According to the Invention

### Preparation of Composition RA According to the Invention

131.34 g of polymer AA dispersion comprising sulphopropionic acid (compound B) (concentration by mass of the dispersion: 55.2%) are mixed with 22.7 g of glycerol (polyfunctional compound C) and 24.2 g of water.

### Preparation of Composition RB According to the Invention

146.46 g of polymer AB dispersion comprising sulphopropionic acid (compound B) (concentration by mass of the dispersion: 49.5%) are mixed with 22.7 g of glycerol (polyfunctional compound C) and 24.2 g of water.

The solids contents of compositions RA and RB and of a glycerol sample are measured by heating them at 110° C. in an oven for 1 hour.

The results (SC1-% by weight) are shown in Table 2.

### Preparation of Composite Materials According to the Invention

1 g of composition RA, respectively of composition RB, is deposited on a glass fibre substrate (Prat Dumas disc made of 100% borosilicate glass microfibres, 90 mm in diameter, 75 g/m² grammage, 480 μm thick). Each disc impregnated with the composition is placed in an oven and heated at 210° C. for 5 minutes. After cooling, the solids content is measured by heating the composite materials obtained after cooking at 210° C. to 110° C. in the oven for 1 hour. The results (SC2-% by weight) are shown in Table 2.

Then, to solubilise any remaining water-soluble substances, the composite materials are immersed in bipermuted water for 1 hour at room temperature. After manual centrifuging, the solids contents of the composite materials are measured by heating them in an oven at 110° C. for 1 hour. The results (SC3-% by weight) are shown in Table 2.

TABLE 2

| | SC1 | SC2 | SC3 |
|---|---|---|---|
| polymer AA dispersion | 55.20 | / | / |
| composition RA in composite | 53.41 | 44.80 | 42.10 |
| polymer AB dispersion | 49.50 | / | / |
| composition RB in composite | 49.23 | 37.30 | 35.40 |

After crosslinking by heating at 210° C., the solids contents SC1 and SC2 of compositions RA and RB in the prepared composites confirm the condensation of the alcohol groups of the glycerol and the carboxylic groups of polymers AA and AB. In addition, the solids contents SC2 and SC3 clearly confirm the formation of water-insoluble cross-linked composites.

1. A method for preparing a composite material, the method comprising:
applying to a material F at least one aqueous composition R comprising:
at least one α-sulphonated polymer A prepared in water and in the absence of any phosphorus compound, by a polymerisation reaction of at least one monomer M selected from the group consisting of acrylic acid, methacrylic acid, an acrylic acid salt, and a methacrylic acid salt, in the presence of at least one initiator compound and of at least one sulphur compound comprising sulphur in oxidation state IV,
at least one compound B selected from the group consisting of a sulpho-carboxylic acid and a sulpho-carboxylic acid salt, present in a molar amount greater than 2% based on a total molar amount of sulphur IV, and
at least one polyfunctional compound C selected from the group consisting of a polyol, a polyamine, an amino alcohol, a (polyamino) alcohol, an amino (polyalcohol), an ose, and an oside, and
crosslinking the material F impregnated with composition R,
wherein the material F is at least one selected from the group consisting of a woven heat-resistant substrate and a non-woven heat-resistant substrate.

2. The method according to claim 1, wherein at least one of the application and the crosslinking is carried out at a pH of less than 5 or wherein the crosslinking is carried out at a temperature ranging from 100 to 250° C.

3. The method according to claim 1, wherein:
the material F is in the form of at least one selected from the group consisting of heat-resistant particles and heat-resistant fibres, or
the material F is selected from the group consisting of aramid fibres, ceramic fibres, non-graphite carbon fibres, polyimide fibres, mineral wool, slag fibres, and glass fibres.

4. The method according to claim 1, wherein:
the method further comprises applying to the material F at least one compound chosen among a compound comprising phosphorus in oxidation state I, a compound comprising phosphorus in oxidation state III, and a compound comprising phosphorus in oxidation state V,
the method further comprises applying to the material F at least one compound chosen among 2-sulphoacetic acid, methane sulphonic acid, para-toluenesulphonic acid (PTSA), sulphuric acid, and salts thereof, or
composition R further comprises at least one compound selected from the group consisting of a compound comprising phosphorus in oxidation state I, a compound comprising phosphorus in oxidation state III, and a compound comprising phosphorus in oxidation state V.

5. The method according to claim 1, wherein:
the method does not involve the use of a urea-formaldehyde compound, a formaldehyde compound, a compound comprising phosphorus in oxidation state I, a compound comprising phosphorus in oxidation state III, or a compound comprising phosphorus in oxidation state V, or
composition R is substantially free of a urea-formaldehyde compound, a formaldehyde compound, a compound comprising phosphorus in oxidation state I, a compound comprising phosphorus in oxidation state III, a compound comprising phosphorus in oxidation state V.

6. The method according to claim 1, wherein:
polymer A is at least one selected from the group consisting of an α-ω-disulphonated polymer A1, and an α-monosulphonated polymer A2,
polymer A has a weight-average molecular mass MW (measured by SEC) less than 20,000 g/mol,
polymer A has a weight-average molecular mass Mw (measured by SEC) greater than 1,000 g/mol, or
polymer A has a polymolecularity index PI (measured by SEC) of less than 4.

7. The method according to claim 1, wherein:
monomer M is at least one selected from the group consisting of acrylic acid and an acrylic acid salt, or
monomer M is combined with at least one other monomer selected from the group consisting of vinyl acetate, ethyl acrylate, methyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, and itaconic acid, or
monomer M is at least one selected from the group consisting of acrylic acid and an acrylic acid salt, combined with at least one other monomer selected from the group consisting of vinyl acetate, ethyl acrylate, methyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, and itaconic acid, or
the sulphur compound is at least one selected from the group consisting of lithium hydrogen sulphite, sodium hydrogen sulphite, potassium hydrogen sulphite, ammonium hydrogen sulphite, calcium di(hydrogen sulphite), and magnesium di(hydrogen sulphite), or
polymer A is non-neutralised or polymer A is partially or completely neutralised.

8. The method according to claim 1, wherein:
the sulphur compound is present in a molar amount of 1% to 15%, based on a total molar amount of monomers used.

9. The method according to claim 1, wherein compound B is at least one selected from the group consisting of a sulpho-carboxy aromatic acid, a sulpho-carboxy aromatic acid salt, a sulpho-carboxy alkyl acid, and a sulpho-carboxy alkyl acid salt.

10. The method according to claim 1, wherein composition R comprises:
a molar amount of compound B greater than 5%, based on a total molar amount of sulphur IV, or
a molar amount of compound B less than 60% based on a total molar amount of sulphur IV.

11. The method according to claim 1, wherein:
compound C is at least one selected from the group consisting of glycerol, a polyalkylene glycol, pentaerythritol, triethanolamine, ethanolamine, diethanolamine, 3-amino-1-propanol, 1-amino-2-propanol, butanetriol, ethylene glycol, 1,3-propanediol, 1,4-butanediol, 1,6-hexanediol, sorbitol, 5-amino-1-pentanol, 2-(2-aminoethoxy) ethanol, N-(2-aminoethyl) ethanolamine, bis(N-hydroxyethyl) propane-1,3-diamine, diisopropanolamine, triisopropanolamine, N-methyldiethanolamine, N-butyldiethanolamine, diethylene glycol, triethylene glycol, 1,2-propanediol, 1,2,3-propanetriol, 1,2-butanediol, 2,3-butanediol, neopentyl glycol, trimethylolpropane, 1,2-pentanediol, 1,5-pentanediol, 2,5-dimethyl-2,5-hexanediol, D-arabinose, L-arabinose, D-xylose, D-glucose, D-mannose, D-galactose, D-glucosamine, D-fructose, maltose, sucrose, lactose, ethylenediamine, diethylenetriamine, triethylenetetramine, 1,3-diaminopropane, 1,2-diaminopropane, neopentyldiamine, hexamethylenediamine, octamethylenediamine, N-(2-aminoethyl) propane-1,3-diamine, 1,2,3-propanetriamine, N,N-bis(3-aminopropylamine) and combinations thereof, or
compound C has a molecular mass ranging from 50 g/mol to 1,000 g/mol.

12. The method according to claim 1, wherein composition R comprises:
a molar amount of functional groups of compound C ranging from 5% to 100%, based on a total molar amount of carboxyl groups of polymer A, or wherein:
a molar amount of compound C ranges from 5% to 100%, based on a total molar amount of monomers.

13. A composite material prepared according to the method defined by claim 1.

14. An aqueous composition R of claim 1.

15. A method for preparing an aqueous composition R of claim 14, comprising:
preparing an aqueous dispersion of polymer A,
adding to the aqueous dispersion of polymer A at least one compound B selected from the group consisting of a sulpho-carboxylic acid and a sulpho-carboxylic acid salt, present in a molar amount of greater than 2% based on a total molar amount of sulphur IV, and
adding at least one polyfunctional compound C selected from the group consisting of a polyol, a polyamine, an amino alcohol, a (polyamino) alcohol, an amino (polyalcohol), an ose, and an oside.

16. A cross-linking agent comprising at least one compound C selected from the group consisting of a polyol, a polyamine, an amino alcohol, a (polyamino) alcohol, an amino (polyalcohol), an ose, and an oside, for crosslinking an aqueous composition R comprising:
at least one α-sulphonated polymer A prepared in water and in the absence of any phosphorus compound, by a polymerisation reaction of at least one monomer M selected from the group consisting of acrylic acid, methacrylic acid, an acrylic acid salt, and a methacrylic acid salt, in the presence of at least one initiator compound and of at least one sulphur compound comprising sulphur in oxidation state IV, and
at least one compound B selected from the group consisting of a sulpho-carboxylic acid, and a sulpho-carboxylic acid salt thereof, and present in a molar amount of greater than 2% based on a total molar amount of sulphur IV.

17. A method for improving the cross-linking property of an aqueous composition R, the method comprising:
adding to the aqueous dispersion of polymer A or to the aqueous composition R at least one compound B selected from the group consisting of a sulpho-carboxylic acid and a sulpho-carboxylic acid salt present in a molar amount greater than 2% based on a total molar amount of sulphur IV, wherein the aqueous composition R comprises
an aqueous dispersion of an α-sulphonated polymer A prepared in water and in the absence of any phosphorus compound, by a polymerisation reaction of at least one monomer M selected from the group consisting of acrylic acid, methacrylic acid, an acrylic acid salt, and a methacrylic acid salt, in the presence of at least one initiator compound and of at least one sulphur compound comprising sulphur in oxidation state IV, and
at least one polyfunctional compound C selected from the group consisting of a polyol, a polyamine, an amino alcohol, a (polyamino) alcohol, an amino (polyalcohol), an ose, and an oside.

18. An agent comprising at least one compound C selected from the group consisting of a polyol, a polyamine, an amino alcohol, a (polyamino) alcohol, an amino (polyalcohol), an ose, and an oside, for improving the cross-linking property of an aqueous composition R comprising:
an aqueous dispersion of an α-sulphonated polymer A prepared in water and in the absence of any phosphorus compound, by a polymerisation reaction of at least one monomer M selected from the group consisting of acrylic acid, methacrylic acid, an acrylic acid salt, and a methacrylic acid salt, in the presence of at least one initiator compound and of at least one sulphur compound comprising sulphur in oxidation state IV, and
at least one compound B selected from the group consisting of a sulpho-carboxylic acid and a sulpho-carboxylic acid salt, present in a molar amount greater than 2% based on a total molar amount of sulphur IV.
